(19) United States
(12) Patent Application Publication
(10) Pub. No.: US 2010/0285266 A1
(43) Pub. Date: Nov. 11, 2010

(54) Plastic composite with earth based bio-fibers

(75) Inventor: Hans Korte, Wismar (DE)

Correspondence Address: THE LAW OFFICES OF DENNIS L. COOK, PLLC, 10004 MARATHON COURT, TAMPA, FL, 33615, US

(73) Assignee: New Polymer Systems, Inc., New Canaan, CT (US)

(21) Appl. No.: 12/387,806

(22) Filed: May 7, 2009

(51) Int. Cl. B32B 5/16; B32B 15/04

(52) U.S. Cl. 428/95; 428/464; 428/535; 428/460

(57) ABSTRACT

A composite made of earth based bio-fibers and polymers is described, wherein the fibers and/or particles are taken from peats or lignite and the polymers are chosen from the group of thermoplastic polymers.

### FIELD OF THE INVENTION

This invention belongs to the field of manufacture of plastic composites. More specifically it is a novel plastic composite made with earth based bio-fibers.

### BACKGROUND OF THE INVENTION

Composites made from natural fibers and thermoplastic resins have been developed as a new material group in the beginning of the 1990s in North America. Mostly the fiber content is more than 50% (w/w), and wood is the most used fiber type. Profile extrusion of wood filled polyolefins is the most used application. A typical example of this technology is given in U.S. Pat. No. 5,516,472. Besides one step direct extrusion two step processes with a compounding step first and an extrusion step second are common (EP 0 667 375 B1).

All known composites of ligno cellulosic fillers and thermoplastic matrix have in common a tendency to take up moisture, swell and therefore increase in length, width and thickness. This is much reduced compared to virgin wood but swelling happens over time in humid environments anyway. If not impregnated with biocides these composites are decayed by micro-organisms if applied having earth or water contact. In processing ligno cellulosic fibers start to smell and to degrade when treated thermally to harden. For wood as an example the thermal decomposition starts at 160° C. Therefore extrusion with polypropylene at 200° C. at the tool at all times is critical in terms of smelling. Higher temperatures cannot be applied without heavy thermal degradation. The present invention aims to overcome swelling, smelling and microbial deterioration by use of earth based bio-fibers.

### BRIEF SUMMARY OF THE INVENTION

This invention is a novel composite made of earth based bio-fibers and polymers, wherein the fibers and/or particles are taken from peats or lignite and the polymers are chosen from the group of thermoplastic polymers.

### DESCRIPTION OF THE PREFERRED EMBODIMENT

The preferred embodiment of the invention discloses a novel composite made of earth based bio-fibers and polymers, wherein the fibers and/or particles are taken from peats or lignite and the polymers are chosen from the group of thermoplastic polymers that overcomes swelling, smelling and microbial deterioration by use of earth based bio-fibers.

Surprisingly this aim can be achieved using earth based bio-fibers or fibrous particles as fillers. Such fibrous material is found in peat as peat fibers and xylite in lignite. Xylite is coalificated wood in lignite. Xylite can be extracted as a side product from lignite exploitation. Due to its fibrous structure xylite can replace wood in making pellets for fuel applications (DE 101 50 074 C1). Lignite xylite is also used as a carrier fiber in garden moulds. Peat fibers are used in a comparable manner to act as seed carriers (U.S. Pat. No. 4,272,919). For technical use xylite varying in size is milled and screened. Overs not passing a 40 mm sieve are put away. To get rid of dust fines passing a 5 mm sieve are also taken off.

The latest research shows that lignite not only is a natural product but can be made synthetically. DE 10 2007 012 112 B3 describes a process for hydrothermal carbonisation of biomass to form lignite. A reactor is fed with biomass, water, and a catalyst and treated between 150 and 250° C. for 2 to 24 hours. After treatment the biomass is coalificated and resembles lignite. The term synthetically coalification shall be seen in a wider context and is not limited to hydrothermal coalification and may include other thermal techniques like pyrolysis etc. Our own hydrothermal coalification experiments using pine shives resulted in coalificated particles comparable to xylite that were used for plastic composites.

The resins used to bind the fibrous material belong to the group of thermoplastic resins. Examples of thermoplastic resins not excluding others are polyolefins, vinyl polymers, polyesters, polyamides, acrylates and thermoplastic polyurethanes (TPU), as homo or co-polymers or their derivatives or mixtures. Examples given, but not excluding others, for polyolefins are linear or branched polyethylene (PE), as low, middle or high density types (LDPE, MDPE, HDPE) or polypropylene (PP), its co-polymers and/or derivatives. Examples given but not excluding others for vinyl polymers are polystyrene (PS) from low to very high molecular weight, with syn- or isotactical orientation, its co-polymers or derivatives e.g. acrylonitrile butadiene styrene (ABS) or acrylonitrile styrene acrylate (ASA), polyvinylchloride (PVC) its co-polymers or derivatives or ethylene vinyl acetate (EVA) its co-polymers or derivatives. Examples given, but not excluding others, for polyesters are polyethylene terephthalate (PET) its co-polymers or derivatives. Examples given, but not excluding others, for polyamides (PA) are polyamide 6 (PA6), polyamide 6.6 (PA6.6) its co-polymers or derivatives. Examples given, but not excluding others, for acrylates are polymethyl methacrylate (PMMA) its co-polymers or derivatives. Included are also hot melts from single polymer types or mixtures of thermoplastic resins and thermoplastic bio-polymers like poly lactic acid (PLA).

The concentration in the invented composite of earth based fibrous material and thermoplastic resin may vary from 10% (w/w) to 90% (w/w) of fibrous material, preferably between 40% (w/w) and 85% (w/w) of fibrous material and favorably between 50% (w/w) and 75% (w/w) of fibrous material. For most technical applications the fiber content is higher than 50% (w/w). When exceeding the given limits of fiber content the claimed advantages of the invented composite may not be given in full extent.

The invented composite has in a preferred embodiment with xylite, a fiber source less than 10% (w/w), preferred less than 5% (w/w) and favorable less than 3% (w/w) of water uptake after 160 min. immersion in boiling water. The composite is dimensionally very stable in moist conditions or storage under water. After 160 minute storage in boiling water dimensional changes in length, width and/or thickness are less than 10%, preferred less than 5% and favorable less than 3%.

The invented composite does not degrade in earth contact. It shows less than 5% (w/w), preferred less than 3% and favorable less than 1% weight loss after 3 month exposure in earth contact.

In a preferred embodiment the composite is covered with layer material to form a sandwich. The covers can be applied one sided, but preferably are double sided. The covers consist preferably of fabrics, films, plates or (fiber) composites. The term fabrics include all types of textiles, fleeces, paper, paper boards or superimposed yarn layers. The fibers in the fabrics may be natural or synthetic or mixtures thereof. The cover layers may be single or multiple layers on one or both sides. The covers are fixed to the centre layer for example by thermal bonding of thermoplastic resins and/or by aid of glues.

In a preferred embodiment the composite centre layer e.g. made of 70% (w/w) xylite and 30% (w/w) polypropylene, not excluding other mixing ratios, is covered with cover layers of composites consisting of one or several fibrous fleeces impregnated with thermoset resins or resin mixtures. Thermoset resins can be e.g. not excluding others, urea-, phenol- and/or melamine resins cross linked with formaldehyde. The favorable fleece materials are paper or glass fibers for ease of access, good price and good performance.

The cover layers may be fixed to the core in a one step process, pressing all layers and the core in one step, or may be fixed to the ready core at a second step bonding the layers to the ready made core.

Sandwich structures of impregnated fleece composite covers on xylite-composite cores are improved in bending strength by 10% or more. Examples of sandwich structures are given in table 1.

TABLE 1
Strength behaviour of xylite- and softwood-plastic composites
with polypropylene (PP) or polystyrene (PS) as matrix and
with or without sandwich cover layers.

| Nr. | Fiber | polymer | cover | bending strength |
|---|---|---|---|---|
| 1 | xylite | PP 30% | — | 20.8 N/mm² |
| | 70% | | | |
| 2 | xylite | PS 30% | — | 28.3 N/mm² |
| | 70% | | | |
| 3 | softwood | PP 30% | — | 24.3 N/mm² |
| | 70% | | | |
| 4 | xylite | PP 30% | glass fleece 60 g | 21.6 N/mm² |
| | 70% | | | |
| 5 | xylite | PP 30% | glass fleece 60 g + 60 g | 33.1 N/mm² |
| | 70% | | MF | |
| 6 | xylite | PP 30% | kraft paper 210 g + 95 g | 36.3 N/mm² |
| | 70% | | PF | |

MF = Melamine Formaldehyde,
PF = Phenol Formaldehyde

Table 1 shows that strength properties of xylite-plastic composites are in the magnitude of (soft) wood-plastic composites. Sandwich structures enhance strength. Especially the sandwiches with melamine formaldehyde impregnated glass fleece or with phenol formaldehyde impregnated kraft paper show performance increases by more than 50%.

The composite of coalificated fibers and plastic shows reduced thermal expansion and shrinkage compared to the unfilled polymer. Preferably the thermal expansion is reduced at least by 50%. The thermal expansion coefficient for the used unfilled polypropylene is about 180*10-6/° K. For the composite with 70% xylite it is about 58*10-6/° K. According to the invention the thermal expansion coefficient of the composite is below 70*10-6/° K.

It is possible to foam the composite in extrusion, injection moulding, or board pressing by use of physical or chemical blowing agents. Without a blowing agent a xylite-polypropylene composite shows a density above 1.1 g/cm³. With the addition of 2% of a blowing agent, e.g. azodicarbonamide (ADC), the densities are below 0.7 g/cm³.

By use of blowing agents the densities of the invented composites are below 0.9 g/cm³, favorably below 0.8 g/cm³ and preferably below 0.7 g/cm³.

Swelling in water is an essential quality criterion for composites. Swelling means on one hand a change in dimension, e.g. elongation in width and/or thickness and/or length, which has to be taken into consideration when using composites in construction. On the other hand uptake of water makes ligno cellulosic material accessible for microbial decay. Table 2 shows water uptake and swelling of composites after immersion in boiling water. Water uptake in boiling water is much more intense compared to water uptake at room conditions. It therefore allows in short time to assume the long time behavior at room conditions.

TABLE 2
Water uptake and swelling of different composites made by
board pressing after 160 minutes immersion in boiling water.

| Nr. | Fiber | polymer | weight increase | volume increase |
|---|---|---|---|---|
| 1 | xylite 70% | PP 30% | 2.5% | 0.3% |
| 2 | softwood 70% | PP 30% | 27.0% | >22.0% |

In an impressive way table 2 shows that the composite using 70% (w/w) of xylite water uptake and swelling are less than 1/10 compared to a composite using 70% (w/w) of softwood.

Due to its high swelling resistance the invented composite is an ideal carrier material for flooring like laminate in potential moist conditions like bath rooms or kitchens.

Examples of the invented composites are given below.

3.5 kg xylite fibers (based on oven dry substance) passed through a screen of 20 mm, 1.5 kg polypropylene (Basell: Moplen HP 500 V) and 0.1 kg blowing agent (Lancess: Porofor ADC/F-C2, reaction temperature 214° C.) are mixed in a fluid and cooling mixer (Henschel FM40/KM85) at 180° C. to a homogeneous agglomerate. 288 g agglomerate is filled into a cavity of 200*200 mm of a preheated board pressing tool of 205° C. The preheated (205° C.) punch fitting into the cavity is put onto the agglomerate and the tool composed of cavity and punch is put into a preheated hot press of 230° C. The press is closed with 14 bar and the agglomerate is compressed and heated up. After 2-3 min the pressure on the press is released to enable the blowing agent to lift up the punch. The opening of the press is fixed in a way that the resulting thickness of the board is 10 mm. When the blowing agent lifts the punch the heating is stopped and cooling of the pressing plates with water injection is started. After about 10 min the press is cooled down to about 50° C. at which the tool can be taken out of the press to deform the composite board. After deburring the board of 200*200*10 mm weighs 252 g. This corresponds to a density of 0.63 g/cm³.

A mixture of 50% (w/w, based on oven dry substance) xylite passed through a 40 mm screen and 50% (w/w) polypropylene (Borealis: HC 205 TF) is agglomerated with a fluid and cooling mixer. The same is done with a mixture of 70% (w/w, based on oven dry substance) xylite and 30% (w/w) polypropylene (Borealis: HC 205 TF). Both agglomerates are injection moulded to form sticks of 100 mm length, 10 mm width and 3.5 mm thickness. Both mixtures can easily be moulded. The performance is given in table 3.

TABLE 3
Bending strength and swelling after 2 hours immersion in boiling
water of xylite-polypropylene composites.

| | | | | | volume |
|---|---|---|---|---|---|
| Nr. | Fiber | polymer | density | bending strength | increase |
| 1 | xylite 50% | PP 50% | 1.07 g/cm³ | 44 N/mm² | 1.16% |
| 2 | xylite 70% | PP 30% | 1.19 g/cm³ | 30 N/mm² | 1.85% |

Example 2. Shives of pine (Pinus sylvestris) were hydrothermal treated for 5.5 h at a maximum temperature of 220° C. and then cooled down over 6,5 h to get synthetic xylite shives. These were dried over night at 80° C. and than for 2 h at 105° C. 50% (w/w) of oven dry shives were mixed with 50% (w/w) of polypropylene powder (Atofina PPC 11712) and pressed to a board at 210° C. and 14 bar. For comparison xylite shives were replaced by softwood particles (LaSoLe CB15E). Strips taken from the boards were tested for bending strength and swelling behavior. Results are given in table 4.

TABLE 4
Bending strength and swelling after 2 hours immersion in boiling water of
synthetic xylite-polypropylene and softwood-polypropylene composites

| | | | bending | weight | volume |
|---|---|---|---|---|---|
| fiber | polymer | density | strength | increase | increase |
| syn. xylite 50% | PP 50% | 1.0 g/cm³ | 18.7 N/mm² | 4.8% | 5.5% |
| softwood 50% | PP 50% | 1.0 g/cm³ | 19.4 N/mm² | 21.4% | 17.7% |

It can be seen that bending strength is in the same range for both fiber types but swelling is 3-4 times less with synthetic xylite as fiber component.

Coalificated fiber plastic composites can be shaped according to the state of the art into foamed or solid bodies by board pressing, extrusion and/or injection moulding.

Since certain changes may be made in the above described composite made of earth based bio-fibers and polymers, wherein the fibers and/or particles are taken from peats or lignite and the polymers are chosen from the group of thermoplastic polymers, it is intended that all matter contained in the description thereof or shown in the accompanying figures shall be interpreted as illustrative and not in a limiting sense.

What is claimed is:

1. A composite from ligno cellulosic fiber or particle and polymers wherein the fibers and/or particles are earth based organic and the polymers belong to the group of thermoplastic polymers.

2. The composite according to claim 1 wherein the fibers and/or particles belong to the group of natural or synthetically produced xylites.

3. The composite according to claim 1 wherein earth based organic fibers and/or particles are peat fibers.

4. The composite according to claim 1 wherein the thermoplastic polymers belong to the group of polyolefins, for example polyethylene (PE) or polypropylene (PP) as well as their co-polymers or their derivatives and/or mixtures.

5. The composite according to claim 1 wherein the thermoplastic polymers belong to the group of vinyl polymers, for example polyvinyl chloride (PVC), polystyrene (PS) or ethylene vinyl acetate (EVA) as well as their co-polymers or their derivatives and/or mixtures.

6. The composite according to claim 1 wherein the thermoplastic polymers belong to the group polyesters, for example polyethylene therephthalate (PET) as well as their co-polymers or their derivatives and/or mixtures.

7. The composite according to claim 1 wherein the thermoplastic polymers belong to the group of polyamides, for example polyamide 6 (PA6), polyamide 6.6 (PA 6.6) as well as their co-polymers or their derivatives and/or mixtures.

8. The composite according to claim 1 wherein the thermoplastic polymers belong to the group of acrylates, for example polymethyl methacrylate (PMMA) as well as their co-polymers or their derivatives and/or mixtures.

9. The composite according to claim 1 wherein the polymer is a thermoplastic bio- polymer such as poly lactic acid (PLA).

10. The composite according to claim 1 wherein the polymer belongs to the group of thermoplastic poly urethanes (TPU).

11. The composite according to claim 1 wherein the polymer belongs to the group of hot melts.

12. The composite according to claim 1 wherein the fiber and/or particle content ranges from 10% (w/w) to 90% (w/w).

13. The composite according to claim 1 wherein the fiber and/or particle content ranges from 40% (w/w) to 85% (w/w).

14. The composite according to claim 1 wherein the fiber and/or particle content ranges from 50% (w/w) to 75% (w/w).

15. The composite according to claim 1 wherein the composite is foamed and reduced in density by use of a physical or chemical blowing agent.

16. The composite according to claim 15 wherein the blowing agent is an exothermal blowing agent, for example azodicarbonamide (ADC) or mixture with ADC.

17. The composite with a sandwich structure with a core according claim 1 and one or double sided sandwich layers wherein the one or double sided sandwich layers consist of sheet metal, foil, textiles, fleece, paper or composite material.

18. The composite according to claim 17 wherein the one or double sided sandwich layers consist of textiles, fleece or paper impregnated with thermoset resins, for example melamine-formaldehyde or phenol-formaldehyde resin.
